(19) United States
(12) Patent Application Publication
(10) Pub. No.: US 2015/0072716 A1
(43) Pub. Date: Mar. 12, 2015

(54) METHOD OF AND SYSTEM FOR CONTROLLING COMMUNICATIONS OVER A PUBLIC SAFETY NETWORK

(71) Applicant: MOTOROLA SOLUTIONS, INC, Schaumburg, IL (US)

(72) Inventor: DAVID E. KLEIN, DAVIE, FL (US)

(73) Assignee: MOTOROLA SOLUTIONS, INC, Schaumburg, IL (US)

(21) Appl. No.: 14/023,914

(22) Filed: Sep. 11, 2013

(51) Int. Cl. H04W 4/22

(52) U.S. Cl. CPC H04W 4/22
USPC 455/516

(57) ABSTRACT

A public safety (PS) device has a channel operating configuration during communications over a PS network. A key term associated with a PS incident is registered on the PS network. The PS network identifies any communication on the PS network that refers to the registered key term, modifies the channel operating configuration in response to such identification, and alerts a PS person operating the PS device to an identified communication by transmitting the identified communication to the PS person via the modified channel operating configuration.

### FIELD OF THE DISCLOSURE

The present disclosure relates generally to a method of, and a system for, controlling communications over a public safety (PS) network, and, more particularly, to controlling a PS communications device, e.g., a land mobile radio, having a channel operating configuration during communications over the PS network, by identifying information or activity relevant to a PS incident, by modifying the channel operating configuration in response to such identification, and by alerting a PS person, such as a first responder, to the relevant information or activity by transmitting the relevant information or activity to the PS person via the modified channel operating configuration.

### BACKGROUND

In an emergency or like incident, public safety (PS) personnel, such as police officers, firefighters, paramedics, emergency medical service technicians, disaster relief workers, military rescue personnel, and like first responders, are typically dispatched to an incident scene to respond to remedy the emergency. These PS personnel typically utilize PS communication devices, both handheld and vehicle-portable, while working in the field. PS communication devices include, for example, land mobile radios (LMRs), such as handheld radios and/or vehicular radios, along with remote accessories, such as remote microphones, speakers, earpieces, headsets, and the like, to support wireless, two-way, voice and data communications. These primary, mission-critical PS devices and the infrastructure to support their operation are typically operated as part of a private, secure, and protected, proprietary PS network governed by a PS agency, e.g., a local government or department.

As advantageous as the known PS networks have been, there are circumstances where a more expedited and effective resolution of the incident is needed. For example, while handling a PS incident, the PS person typically listens to a selected channel on his or her PS device and, if there is no or little activity over the selected channel, then the PS person typically listens to a predetermined scan list of channels through which the PS device repetitively cycles. Typically, the channels in the scan list are delivering a significant amount of information, but the PS person might not readily appreciate the relevance of any one particular piece of information on one of the channels amid the noise of all the information being delivered on all the channels, or, more likely, may be distracted by the circumstances of the incident, or may not have sufficient time to filter out the relevant information. A PS person may talk to another PS person or to a human operator at a dispatch center to retrieve information from databases, e.g., license plate records or criminal records, but the response times may be lengthy and, when the other PS person or human operator responds over one of the channels, the requested information may again get lost in all the noise.

Accordingly, there is a need for an improved PS network communications system and method that will alleviate the aforementioned problems and enable a more expedited and more effective resolution of a PS incident by automatically alerting and delivering information and/or activity relevant to the incident to the PS person in a manner that is likely to capture the attention of the PS person.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a pictorial, schematic view of a PS network whose communications are to be controlled in accordance with the present disclosure.

FIG. 2 is a flow chart, wherein various initial steps of a method of controlling the system of FIG. 1 are set forth.

FIG. 3 is a flow chart, wherein various further steps of the method of controlling the system of FIG. 1 are set forth.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One aspect of this disclosure relates to a method of controlling communications over a public safety (PS) network. The method is performed by providing a PS person with a PS device having a channel operating configuration during communications over the PS network, by registering on the PS network at least one key term, and preferably a plurality of key terms, associated with an incident, by monitoring the PS network to identify a communication, e.g., call activity or database information, referring to each registered key term, modifying the channel operating configuration in response to an identified communication, and by alerting the PS person to the identified communication via the modified channel operating configuration.

The channel operating configuration of the PS device is configured with a selected communications channel, as well as a plurality of communications channels arranged in a scan list through which the PS device repetitively cycles, especially when there is no or little activity over the selected channel. In one embodiment, when a registered key term in a dispatch voice call with a dispatch center is identified on the PS network, then a channel is added to the scan list, and the PS person is connected to the dispatch center over the added channel, and the identified communication is transmitted to the PS person over the added channel. In another embodiment, when a registered key term in a voice in-field call with another PS person is identified on the PS network, then a priority channel is added to the scan list, and the PS person is connected to the other PS person over the added priority channel, and the identified communication is transmitted to the PS person over the added priority channel. In still another embodiment, when a registered key term in a emergency voice, in-field or dispatch, call with another PS person or a dispatch center is identified on the PS network, then the PS device is switched to the selected channel, and the PS person is connected to the other PS person or the dispatch center over the selected channel, and the identified communication is transmitted to the PS person over the selected channel. In yet another embodiment, when a registered key term in a voice call with another in-field PS person located in close proximity with the PS person is identified on the PS network, then the PS device is switched to the selected channel, and the PS person is connected to the other proximally located in-field PS person over the selected channel, and the identified communication is transmitted to the PS person over the selected channel.

A system, in accordance with another aspect of this disclosure, is operative for controlling communications over a public safety (PS) network. The system includes a PS device operated by a PS person. The PS device has a channel operating configuration during communications over the PS network. The system further includes a relational database in which at least one key term, and preferably a plurality of key terms, associated with an incident is registered. The system still further includes a PS server for monitoring the PS network to identify a communication, e.g., call activity or database information, referring to each registered key term, for modifying the channel operating configuration in response to an identified communication, and for alerting the PS person to the identified communication via the modified channel operating configuration.

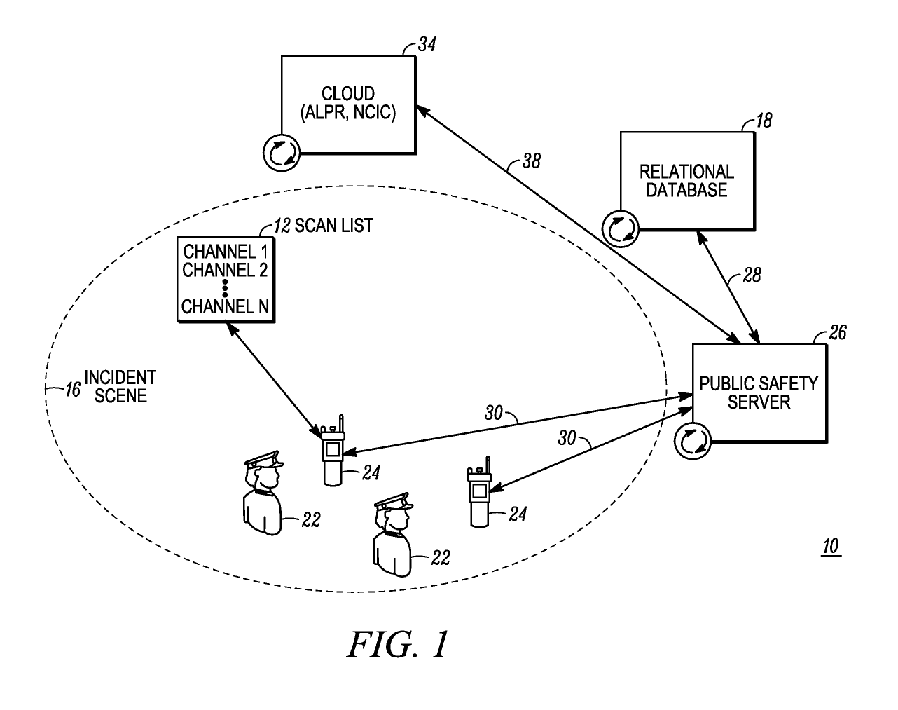

Turning now to the drawings, reference numeral 10 in FIG. 1 generally identifies a public safety (PS) network whose communications are to be controlled. In an emergency or PS incident, one or more PS personnel 22, such as police officers, firefighters, paramedics, emergency medical service technicians, disaster relief workers, military rescue personnel, and like first responders, are dispatched to an incident scene 16 to respond to the incident. These PS personnel 22 typically utilize PS communication devices 24, both handheld and vehicle-portable, while working in the field. PS devices 24 include, for example, land mobile radios (LMRs), such as handheld radios and/or vehicular radios, along with remote accessories, such as remote microphones, speakers, earpieces, headsets, and the like, to support wireless, two-way, voice and data communications. These primary, mission-critical PS devices 24 and the infrastructure to support their operation are typically operated as part of the private, secure, and protected, proprietary PS network 10 governed by a PS agency, e.g., a local government or department, over bidirectional wireless links 30 connected to a PS server 26.

Each PS device 24 typically has a channel operating configuration during communications over the PS network 10. This channel operating configuration includes a selected bidirectional channel, also known as a primary or a default channel, over which the PS person 22 normally communicates over the PS network 10. In addition, this channel operating configuration includes a scan list 12 consisting of a plurality of bidirectional channels 1, 2, . . . N. The scan list 12 is a group of channels through which the PS device 24 repetitively cycles during communications over the PS network 10, especially when there is no or little activity over the selected channel. The PS person 22 typically listens to all the channels in the scan list 12 as they cycle. Channels may be added manually in the scan list, or the scan list may be preprogrammed with preselected channels. The selected channel may, or may not, be one of the channels in the scan list 12. Each PS device 24 typically has a keyboard (real or electronic), a GPS sensor, a microphone, an on-board memory and microprocessor for storing and running applications and a mobile operating system, a display screen, and a radio frequency (RF) transceiver for communicating with the PS server 26 over the bidirectional wireless link 30.

As described in detail below, at least one key term, and preferably a plurality of key terms, associated with the incident is registered on the PS network 10. This can be done, for example, by the PS person 22 speaking at least one key term, and/or keying at least one key term by keyboard entry, into his or her PS device 24. The PS server 26 then stores the registered key term, as well as other information, in a relational database 18 via a bidirectional wireless link 28. The PS server 26 then monitors the PS network 10 to identify any communication referring to the registered key term. This communication, as described below, can be a call, e.g., a dispatch call, an in-field call, an emergency call, a geographically close call, and like voice calls, or this communication can be a database look-up data match. If the PS server 26 identifies any such communication, then the PS server 26 modifies the channel operating configuration, as described below, and alerts the PS person 22 to the identified communication and transmits the identified communication to the PS person 22 via the modified channel operating configuration. The PS server 26 may also monitor applications that access a cloud database 34, for example, an automatic license plate recognition (ALPR) database, or a national criminal information center (NCIC) database, via a bidirectional wireless link 38, and deliver such information via the modified channel operating configuration. Each link 28, 30 and 38 may operate under the Wi-Fi, 2G, 3G, 4G, or long-term evolution (LTE), standard, and like standards, all of which are open protocols for wireless transmission of voice and data.

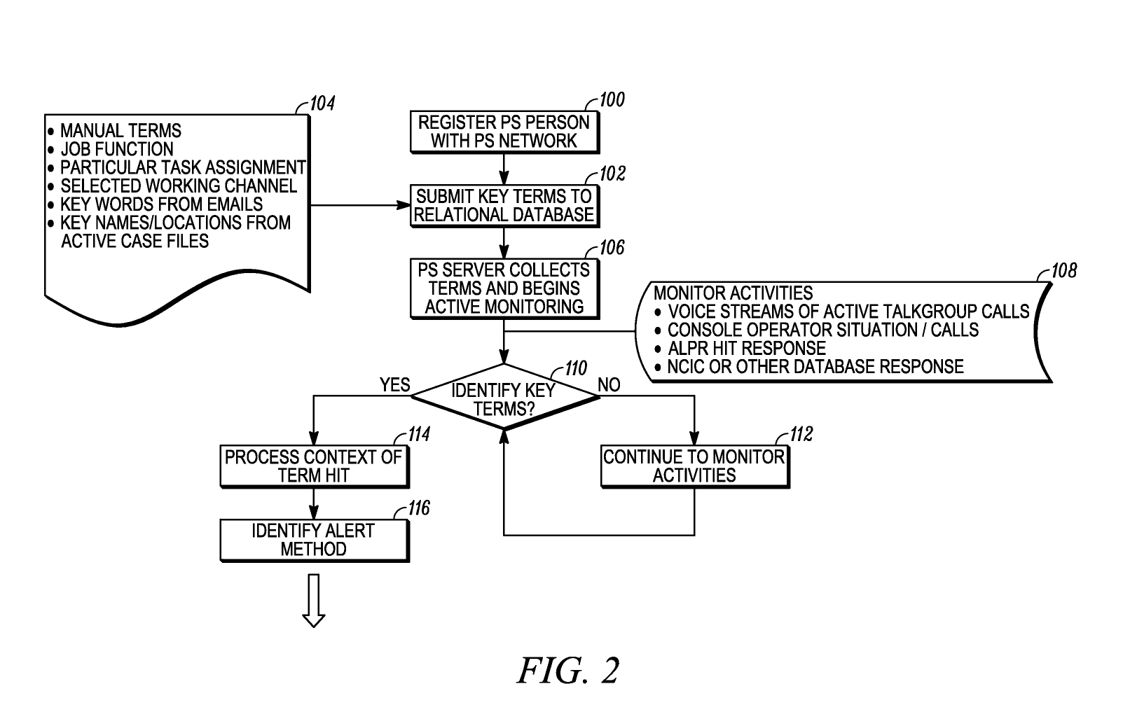

Referring now to the flow chart of FIG. 2, the PS person 22 is initially registered with the PS network 10 at step 100. Then, one or more key terms, i.e., information, such as words, names of people or associates, and descriptions of places or things, relevant to the incident, are submitted to the PS server 26 for storage in the database 18 in step 102. As shown in block 104, such key terms may be manually entered, e.g., orally or keying, via the PS device 24, or may be automatically assigned to the PS person 22. Such key terms may include the job function of the PS person, e.g., a description of the type of incident, for example, homicide, vice, robbery, etc.; the particular task assignment; and an identification of the selected channel. The key terms can also be contained in emails and/or active case files located on computers accessible over the PS network 10.

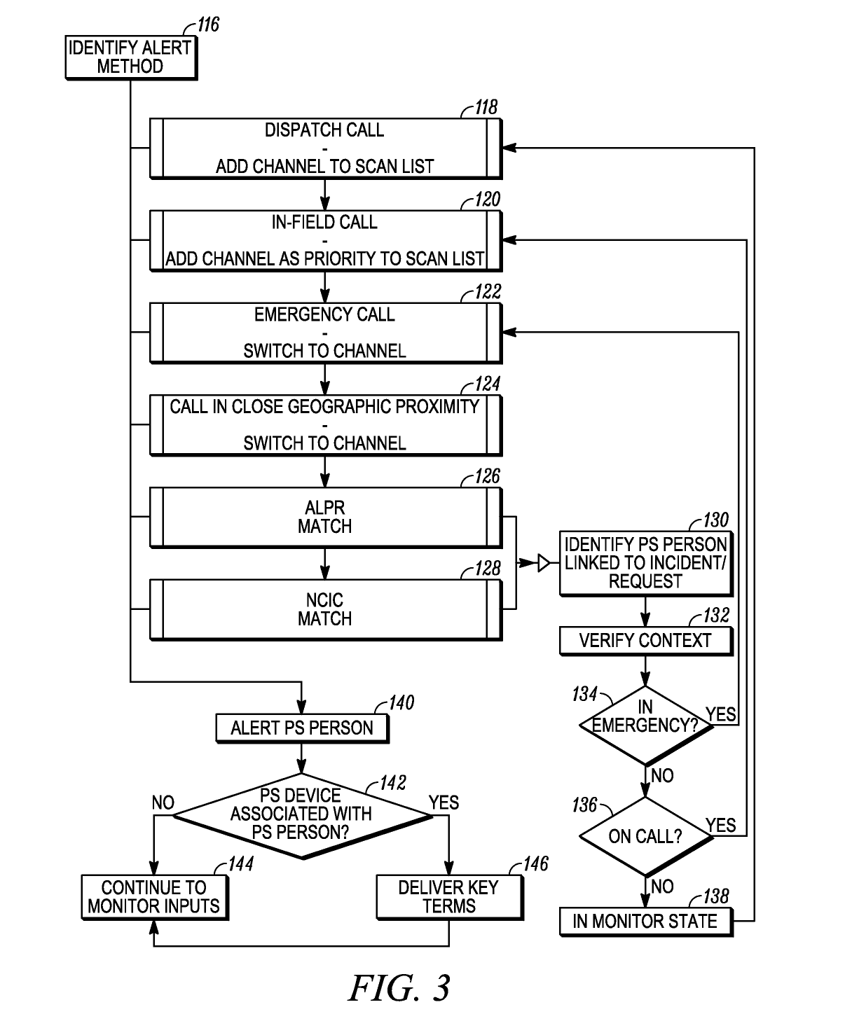

The PS server 26 collects all the registered terms and begins active monitoring to find any mention or identification of these terms over the PS network 26 at step 106. As shown in block 108, such monitoring includes monitoring the voice streams of any active calls, e.g., from any other PS device, or from a human console operator at a call or dispatch center, or monitoring announcement events, such as a be-on-the-lookout (BOLO) event, or an Amber/Silver alert, as well as monitoring applications that access the records of the ALPR database and/or NCIC database and/or any like database in the cloud 34. If the PS server 26 does not identify any key term in decision step 110, then it continues monitoring in step 112. However, if the PS server 26 does identify any key term, then the context of the key term match or “hit” is processed in step 114, and one of several alert methods, as more fully set forth in FIG. 3, is identified in step 116.

One of the alert methods, as depicted in block 118, is to modify the channel operating configuration by editing the scan list 12 by adding a channel to the scan list 12 in the event that a dispatch call, i.e., a call between the PS person 22 and the dispatch center, referred to the key term. In this case, the PS person 22 is connected to the dispatch center over the added channel, and the identified communication is transmitted to the PS person 22 over the added channel.

Another of the alert methods, as depicted in block 120, is to modify the channel operating configuration by editing the scan list 12 by adding a channel as a priority channel to the scan list 12 in the event that an infield call, i.e., a call between PS persons 22, referred to the key term. In this case, the PS person 22 is connected to the other PS person over the added priority channel, and the identified communication is transmitted to the PS person 22 over the added priority channel.

Yet another of the alert methods, as depicted in block 122, is to modify the channel operating configuration by switching the PS device 24 to the selected channel in the event that an emergency call referred to the key term. The emergency call can be an in-field call or a dispatch call. In this case, the PS person 22 is connected to the party that initiated the emergency call, i.e., the other PS person or the dispatch center, over the selected channel, and the identified communication is transmitted to the PS person 22 over the selected channel.

An additional alert method, as depicted in block 124, is to modify the channel operating configuration by switching the PS device 24 to the selected channel in the event that a call over a second PS device in close geographic proximity to a first PS device 24 referred to the key term. In this case, the PS person 22 is connected to the other proximally located in-field PS person over the selected channel, and the identified communication is transmitted to the PS person 22 over the selected channel.

In the event that an ALPR match was made in block 126, and/or an NCIC match was made in block 128, then the PS server 26 identifies the PS person 22 linked to the data request and the incident in step 130, and then verifies the context of the incident in step 132. For example, if the incident is determined by the PS network 10 to be an emergency in step 134, then the PS device 24 is switched by the PS server 26 to the selected channel, as for an emergency call (block 122), and the retrieved database information is delivered to the PS person 22 over the selected channel. If the incident is determined by the PS network 10 to be an on-call state (the PS person 22 has been assigned to the incident) in step 136, then a channel is added by the PS server 26 as a priority channel to the scan list 12, as for an in-field call (block 120), and the retrieved database information is delivered to the PS person 22 over the added priority channel. Otherwise, the incident is determined by the PS network 10 to be an in-monitor state (the PS person 22 has not been assigned to the incident) in step 138, and a channel is added by the PS server 26 to the scan list 12, as for a dispatch call (block 118), and the retrieved database information is delivered to the PS person 22 over the added channel.

The PS person 22 is alerted that a key term match has been identified in step 140, and then the PS server 26 determines in decision block 142 what PS device(s) 24 are associated with that PS person 22. Then, in step 146, the identified communication is automatically delivered via the modified channel operating configuration. The delivery can be made to the handheld PS device 24, or to a vehicle-mounted PS device, also known as a mobile data terminal (MDT), or to a computer, or a tablet. If no PS device is identified, or after delivery of the identified communication, the PS server 26 continues its monitoring function in step 144.

The attention of the PS person 22 to the relevant information is more likely to be captured due to the edited scan list 12, or the selected channel change. It would be difficult to ignore any information delivered on the selected channel. If a channel is added to the scan list, then again, it would be less likely to be ignored, especially if the added channel is assigned a priority. For example, information on the priority channel can be transmitted for a longer time, or repeated more frequently, or more loudly, to insure that it will not be missed.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of controlling communications over a public safety (PS) network, the method comprising:
providing a PS person with a PS device having a channel operating configuration during communications over the PS network;
registering on the PS network a key term associated with an incident;
monitoring the PS network to identify a communication referring to the registered key term;
modifying the channel operating configuration in response to an identified communication; and
alerting the PS person to the identified communication via the modified channel operating configuration.

2. The method of claim 1, wherein the registering is performed by manually entering the key term via the PS device, and by storing the manually entered key term on the PS network.

3. The method of claim 1, wherein the registering is performed by computer entry of the key term onto the PS network, and by storing the entered key term on the PS network.

4. The method of claim 1, and configuring the channel operating configuration with a plurality of communications channels arranged in a scan list through which the PS device cycles during communications over the PS network; wherein the monitoring is performed by monitoring dispatch voice calls with a dispatch center on the PS network; wherein the modifying is performed by adding a channel to the scan list; and wherein the alerting is performed by connecting the PS person to the dispatch center over the added channel, and by transmitting the identified communication to the PS person over the added channel.

5. The method of claim 1, and configuring the channel operating configuration with a plurality of communications channels arranged in a scan list through which the PS device cycles during communications over the PS network; wherein the monitoring is performed by monitoring voice in-field calls with another PS person on the PS network; wherein the modifying is performed by adding a priority channel to the scan list; and wherein the alerting is performed by connecting the PS person to the other PS person over the added priority channel, and by transmitting the identified communication to the PS person over the added priority channel.

6. The method of claim 1, and configuring the channel operating configuration with a selected communications channel during communications over the PS network; wherein the monitoring is performed by monitoring emergency voice, in-field or dispatch, calls with another PS person or a dispatch center on the PS network; wherein the modifying is performed by switching to the selected channel; and wherein the alerting is performed by connecting the PS person to the other PS person or the dispatch center over the selected channel, and by transmitting the identified communication to the PS person over the selected channel.

7. The method of claim 1, and configuring the channel operating configuration with a selected communications channel during communications over the PS network; wherein the monitoring is performed by monitoring a voice call with another in-field PS person located in close geographic proximity with the PS person on the PS network; wherein the modifying is performed by switching to the selected channel; and wherein the alerting is performed by connecting the PS person to the other proximally located in-field PS person over the selected channel, and by transmitting the identified communication to the PS person over the selected channel.

8. The method of claim 1, and configuring the channel operating configuration with a selected communications channel; wherein the monitoring is performed by monitoring the registered key term on a database on the PS network to retrieve data relating to the incident; and determining whether the incident is an emergency; wherein the modifying is performed by switching to the selected channel upon the determination of the emergency; and wherein the alerting is performed by delivering the retrieved data to the PS person over the selected channel during the emergency.

9. The method of claim 1, and configuring the channel operating configuration with a plurality of communications channels arranged in a scan list through which the PS device cycles; wherein the monitoring is performed by monitoring the registered key term on a database on the PS network to retrieve data relating to the incident; and determining whether the PS person has been assigned to the incident; wherein the modifying is performed by adding a priority channel to the scan list upon the determination that the PS person has been assigned; and wherein the alerting is performed by delivering the retrieved data to the assigned PS person over the added priority channel.

10. The method of claim 1, wherein the registering is performed by entering additional key terms via the PS device, and by storing each entered key term on the PS network; wherein the registering is performed by monitoring the PS network to identify each communication referring to each registered key term; wherein the modifying is performed by modifying the channel operating configuration in response to each identified communication; and wherein the alerting is performed by alerting the PS person to each identified communication by transmitting each identified communication to the PS person via each modified channel operating configuration.

11. A system for controlling communications over a public safety (PS) network, the system comprising:
a PS device operated by a PS person, the PS device having a channel operating configuration during communications over the PS network;
a relational database in which a key term associated with an incident is registered; and
a PS server for monitoring the PS network to identify a communication referring to the registered key term, for modifying the channel operating configuration in response to an identified communication, and for alerting the PS person to the identified communication via the modified channel operating configuration.

12. The system of claim 11, wherein the PS device has manual inputs for manually entering the key term via the PS device, and wherein the relational database stores the manually entered key term on the PS network.

13. The system of claim 11, wherein the channel operating configuration has a plurality of communications channels arranged in a scan list through which the PS device cycles during communications over the PS network; and wherein the PS server is operative for monitoring dispatch voice calls with a dispatch center on the PS network, for adding a channel to the scan list, for connecting the PS person to the dispatch center over the added channel, and for transmitting the identified communication to the PS person over the added channel.

14. The system of claim 11, wherein the channel operating configuration has a plurality of communications channels arranged in a scan list through which the PS device cycles during communications over the PS network; and wherein the PS server is operative for monitoring voice in-field calls with another PS person on the PS network, for adding a priority channel to the scan list, for connecting the PS person to the other PS person over the added priority channel, and for transmitting the identified communication to the PS person over the added priority channel.

15. The system of claim 11, wherein the channel operating configuration has a selected communications channel during communications over the PS network; and wherein the PS server is operative for monitoring emergency voice, in-field or dispatch, calls with another PS person or a dispatch center on the PS network, for switching to the selected channel, for connecting the PS person to the other PS person or the dispatch center over the selected channel, and for transmitting the identified communication to the PS person over the selected channel.

16. The system of claim 11, wherein the channel operating configuration has a selected communications channel during communications over the PS network; and wherein the PS server is operative for monitoring a voice call with another in-field PS person located in close proximity with the PS person on the PS network, for switching to the selected channel, for connecting the PS person to the other proximally located in-field PS person over the selected channel, and for transmitting the identified communication to the PS person over the selected channel.

17. The system of claim 11, wherein the channel operating configuration has a selected communications channel during communications over the PS network; and wherein the PS server is operative for monitoring the registered key term on a database on the PS network to retrieve data relating to the incident, for determining whether the incident is an emergency, for switching to the selected channel upon the determination of the emergency, and for delivering the retrieved data to the PS person over the selected channel during the emergency.

18. The system of claim 11, wherein the channel operating configuration has a plurality of communications channels arranged in a scan list through which the PS device cycles; and wherein the PS server is operative for monitoring the registered key term on a database on the PS network to retrieve data relating to the incident, for determining whether the PS person has been assigned to the incident, for adding a priority channel to the scan list, and for delivering the retrieved data to the assigned PS person over the added priority channel.

19. The system of claim 11, wherein the channel operating configuration has a plurality of communications channels arranged in a scan list through which the PS device cycles during communications over the PS network; and wherein the scan list is a subset of all the channels on the PS device.

20. The system of claim 11, wherein the PS device is a handheld land mobile radio.
